(19) United States
(12) Patent Application Publication
(10) Pub. No.: US 2010/0241868 A1
(43) Pub. Date: Sep. 23, 2010

(54) METHOD AND APPARATUS FOR STORING, MANAGING, AND SECURING PERSONAL INFORMATION

(76) Inventors: Hani Nachef, (US); Richard Saad, (US)

Correspondence Address: SHEPPARD, MULLIN, RICHTER & HAMPTON LLP, 12275 EL CAMINO REAL, SUITE 200, SAN DIEGO, CA, 92130, US

(21) Appl. No.: 12/407,721

(22) Filed: Mar. 19, 2009

(51) Int. Cl. G06F 21/00; G06F 13/00

(52) U.S. Cl. 713/186; 713/185; 711/103

(57) ABSTRACT

Some embodiments of the invention work in conjunction with a portable device, which when attached to a computing device invokes operations for storing personal information on the portable device, retrieving personal information from the portable device, encrypting personal information on the portable device, and decrypting information from the portable device. For these embodiments, the operations reside on the portable device and remain there during their performance. The operations are performed on the computing device, but are not permanently installed onto the computing device during performance. In addition, once the operations of these embodiments cease performance on the computing device, all data temporarily transferred from the portable device to the computing device during operation. In particular, any sensitive information that is stored and retrieved during the operations is removed from the computing device.

### FIELD OF THE INVENTION

The present invention pertains to information storage and retrieval, and more particularly, pertains to secure storage and secure retrieval of personal information on a device that is easily transportable.

### DESCRIPTION OF THE RELATED ART

Today's individual has a large quantity of information that exists relating to them. Although some portions of information may be publicly known, much of the information is considered confidential and personally sensitive in nature. It is, therefore, no surprise that individuals usually prefer such information be maintained in a confidential manner, secure from unauthorized viewing and access. This, however, has become increasingly difficult as more and more sensitive information is generated and used on a day to day basis.

Information from a variety of categories fall within this the sensitive information realm. Social security numbers, passport numbers, driver's license numbers, student identification numbers, and other identification information are just some of the most common forms of sensitive information. Usually, such identification information is written to a card or booklet that an individual can conveniently carry. Login names and passwords are yet another form of sensitive information, used almost day to day by individuals to login into computers, applications, and websites. In fact, many individuals who use the Internet today have multiple online accounts for banking, investments, credit cards, paying bills, personalized websites, and the like. Sensitive information also covers bank account numbers, credit card numbers, and medical identification numbers.

Unfortunately, as the amount of sensitive information an individual possesses increases, so does the need to store, track, and retrieve the information safely and securely. Additionally, while the individual wants to secure this information from unauthorized access, he or she also desires access to the sensitive information that is easy, readily available, and secure.

Although several solutions exist to overcome these challenges, including computer programs that assist in storing, tracking and managing login usernames and passwords, these solutions are limited to securely storing only login information, and operate in a manner that increases the likelihood of unauthorized access.

### BRIEF SUMMARY OF EMBODIMENTS OF THE INVENTION

The embodiments of the present invention provide systems, methods, and apparatuses for storing, retrieving, and managing information. Specifically, some embodiments of the invention work in conjunction with a portable device, which when attached to a computing device, invokes operations for storing personal information on the portable device, retrieving personal information from the portable device, encrypting personal information on the portable device, and decrypting information from the portable device. For these embodiments, the operations reside on the portable device and remain there during their performance. The operations are performed on the computing device, but are not permanently installed onto the computing device during performance. In addition, once the operations of these embodiments cease performance on the computing device, all data temporarily transferred from the portable device to the computing device during operation is removed. In particular, any sensitive information that is stored and retrieved during the operations is removed from the computing device.

In one embodiment of the invention, a computer program product having instructions embedded in a computer useable medium is provided. The instructions are configured to cause a processor to perform the operations of: authenticating a user by confirming one or more user credentials; receiving sensitive information as a dataset; encrypting the dataset using a cipher; and storing the dataset on the portable device. In further embodiments, a computer program product having instructions embedded in a computer useable medium is provided in which the instructions are configured to cause a processor to perform the operations of: authenticating a user by confirming one or more user credentials; retrieving the dataset from the portable device; decrypting the dataset using the cipher, and outputting the dataset as sensitive information. Within either of the embodiments, the instructions are invoked when the portable device is attached to a computing device. Additionally, the instructions reside on the portable device and remain there during execution of the instructions. Once terminated, the instructions remove temporary data that was transferred from the portable device to the computing device during execution of the instructions. For some embodiments, the operations performed further comprise establishing an initial setup after the instructions of the embodiment are invoked.

In additional embodiments of the invention, the outputting of the sensitive information further involves exporting the sensitive information to an external file or to an application running on the computing device.

Within some embodiments, the one or more user credentials utilized during authentication include a username and password, a personal identification number, and biometric information. Additionally, in some embodiments, the operation of authenticating the user involves authentication of one or more of the user credentials against a user list or user group. Further embodiments use these one or more user credentials as a key for the cipher utilized during encryption and decryption of the personal information.

With regard to the sensitive information, some embodiments of the invention include identification information, general security information, and system credentials as sensitive information. Such identification information may include without limitation a driver's license number, a passport number, a social security number, a student identification number, and an employee identification number; general security information includes a credit card personal identification number, an automatic teller machine personal identification number, a lock combination, a credit card number, a bank account number, and a general account number. In addition, system credentials may include, but are not limited to, a username and password for a Internet website, a username and password for a intranet website, a username and password for an application, a username and password for a document, and a username and password for an operating system.

In some embodiments, the operations of encrypting and storing the dataset are performed concurrently. In other embodiments, the operations of retrieving and decrypting the dataset are performed concurrently. In further embodiments, the dataset is stored in one or more databases residing on the portable device. Additionally, in yet further embodiments, the dataset is retrieved from one or more databases residing on the portable device.

In terms of portable devices, some embodiments of the invention utilize a portable device that is either a portable storage device or a hand-held device. In addition, within some embodiments, the portable storage device includes a flash memory device, a secure digital memory card, a removable USB drive, an external hard disk device, and an external solid state hard disk device; and the hand-held device includes a personal digital assistant, a smartphone, or a portable media player.

In yet further embodiments, the portable device attaches to the computing device through a physical interface or wireless interface. For some such embodiments, the physical interface includes a serial port, a USB, a Firewire port, and an eSATA port; and the wireless interface includes a Bluetooth interface, a wireless USB, or a wireless LAN interface.

The computing device within some embodiments includes a personal computer, laptop, personal digital assistant, smartphone, or gaming console.

In some embodiments, the processor that executes instructions in accordance with the invention resides in the portable device.

Yet further embodiments of the invention comprise a portable device that carries instructions that cause a processor to operate in accordance with the invention features described above.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a flowchart illustrating example operations for storage of sensitive information in accordance with one embodiment of the invention.

FIG. 2 is a flowchart illustrating example operations for retrieval of sensitive information in accordance with one embodiment of the invention.

FIG. 3 is a diagram illustrating an example computing module that can be used in conjunction with an embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Various embodiments of the present invention provide systems, methods and apparatuses directed toward secure storage and retrieval of sensitive information to and from a portable device that attaches to a computing device. Particular embodiments of the invention enable a user to store sensitive data, such their login IDs (i.e. usernames) and passwords, securely in an encrypted datastore residing on the portable device. This data is then retrievable at a future time and date. In accordance with these particular embodiments, the user's identification must first be authenticated using one or more credentials before the sensitive data can be stored, retrieved and managed.

In order to facilitate this process, these particular embodiments are implemented as instructions operable on the computer device to which it is attached. The instructions are self-contained such that they reside on the portable device with the stored sensitive data, and require no pre-configuration or installation on the computing device before they can be executed. In other words, within these embodiments, the instructions can be executed by the computing device directly from the portable device without the need to permanently transfer the instructions to the computing device, and without the need for installation of any third-party instructions onto the computing device.

The instructions within these embodiments are also self-executing in that they are invoked and executed when the portable device is attached to the computing device (a feature referred to as plug-and-play and auto-run). For example, if one of these embodiments were implemented on a universal serial bus (USB) memory stick, once the USB memory stick is attached to a computing device, the instructions on the memory stick would be invoked and begin to execute on the computing device. If the USB memory stick has an existing configuration for one or more users, the instructions would cause the computing device to prompt the current user for his or her login and password before access is granted to the encrypted datastore. Alternatively, if no users have been configured on the USB memory stick (e.g., no encrypted datastore or user configuration exists on the portable device), the instructions invoked would begin a setup process for the new user or user groups.

Optionally, the user can invoke the setup process during the authentication process to modify an existing configuration on the portable device. The setup process can also be utilized to establish a series of security questions and answers for a particular user, which can be later utilized in the event that a user forgets his or her username and password to the encrypted datastore. Additionally, the setup process may be protected by an administrative username and password as well.

In addition to storage and retrieval of sensitive data, various embodiments of the invention provide features for managing the information stored within the encrypted datastore. The management features include addition and deletion functions for the information, as well as categorization functions for the information. With regards to the datastore on the portable device, embodiments may comprise such data structures as files, tables, or databases, that either can be encrypted in their entirety, or can have only its entries encrypted when information is entered into them.

It should be noted that the embodiments as described above can support one or more users and one or more user groups. In doing so, these embodiments support multiple user configurations where each user or user group can either be associated with a single encrypted datastore, or multiple encrypted datastore.

The variety of portable devices upon which various embodiments of the invention can be implemented differ in both device type and interface type. The types of portable devices include, but are not limited to, hand-held devices, such as personal digital assistants (PDA's), smartphones, and portable media players; or storage devices, such as flash memory (e.g., USB memory stick), SD cards, external hard disk drives, and the like. Optionally, such devices may also incorporate a biometric reader (e.g., fingerprint scanner), which providing another form of user credentials when accessing the encrypted datastore. With respect to interface types, various wired and wireless communication channels can be utilized to attach the portable device to the computing device, including universal serial bus (USB), external Serial ATA (eSATA), Firewire (IEEE 1394), Bluetooth®, wireless USB, and various wireless network interfaces (e.g., IEEE 802.11x).

In terms of the types of sensitive information (i.e., data) storable in the encrypted datastore, the sensitive information includes such things as login (i.e., username and password) for various computers, applications, and websites; driver's license numbers, passport numbers, social security numbers, identification numbers (e.g., student, employee); ATM pin numbers; lock combination (e.g, to a safe); bank account numbers; and credit card numbers. After reading the foregoing list of examples, a person of ordinary skill in the art would appreciate that the type of information stored in the encrypted datastore extends to any type of information considered private and personally sensitive.

The following description of example embodiments is presented to enable any person skilled in the art to make and use the invention. Various modifications to these and other embodiments described herein will be readily apparent to those skilled in the art. Accordingly, the general principles defined herein may be applied to other embodiments and applications without departing from the spirit and scope of the invention. The present invention is not intended to be limited to the embodiments shown, but is to be accorded the widest scope consistent with the principles and features disclosed herein.

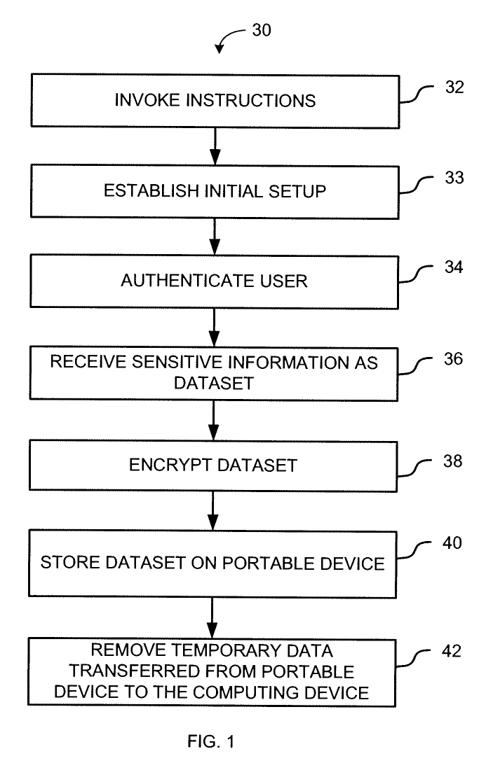

Referring now to the drawings and more particularly to FIG. 1, a flowchart is provided illustrating example operations 30 for storage of sensitive information in accordance with one embodiment of the invention. The series of operations 30 begins at operation 32, with the invocation of the instructions on the computing device to which the portable device is attached. The instructions cause the processor of the computing device to perform the operations that follow operation 32 (i.e., operations 34-42). Operation 32 is typically performed when the portable device embodying principles of the invention is attached to the computing device. Alternatively, when the portable device is attached to the computing device, operation 32 can prompt the user before invoking the instructions.

At operation 33, if there are no preexisting users or encrypted datastores configured on the portable device, an initial setup for the embodiment can be established through a setup process. As previously described, the setup process allows the user to add, delete or reconfigure users and user groups. The setup process can also assist in establishing a series of security questions and answers for a user in case the user forgets his or her username and password to the encrypted datastore. For deleting or reconfiguring existing users or user groups, the setup process may optionally be guarded by an administrative login process (e.g., admin username and password), as to prevent unauthorized reconfiguration of the embodiment. Additionally, this optional administrative login may be provided through operation 34, which is described in greater detail below.

Operation 34 involves the authentication of a user. In order to facilitate the authentication process, a user provides one or more forms of user credentials to verify his or her identity. In place or in addition to a username and password, some embodiments may utilize biometric information, such as a retinal scan or a fingerprint as a form of user credentials.

Once a user is authenticated, the user may choose to add sensitive information to the encrypted database. Accordingly, operation 36 receives the information from the authenticated user as a dataset. As mentioned earlier, the types of information that can be stored in the encrypted datastore range from identification information to personal information. Once the sensitive information is received, the dataset containing the information is encrypted using one of several well-known encryption algorithms (i.e., ciphers). The encrypted information is then stored on the portable device at operation 40, into a form of datastore that resides on the portable device. Within some embodiments, the encryption process of operation 38 and storage process of operation 40 occur concurrently, rather than sequentially. Additionally, the cipher can utilize the user credentials provided during the authentication process (operation 34) as a key in the encryption process.

Subsequent to storing the sensitive information dataset, operation 42 removes any temporary data that may have been transferred from the portable device to the computing device during the embodiment's performance (i.e., execution of instructions). Such temporary data may reside in the computing device in a variety of locations including, but not limited to, a temporary memory space, RAM, or the hard disk drive. By performing operation 42, no remnants of the embodiment remains on the computing device once the embodiment has terminated operation. In addition, other applications or processes running on the computing device cannot obtain sensitive information previously received, encrypted and stored by during operation of the embodiment.

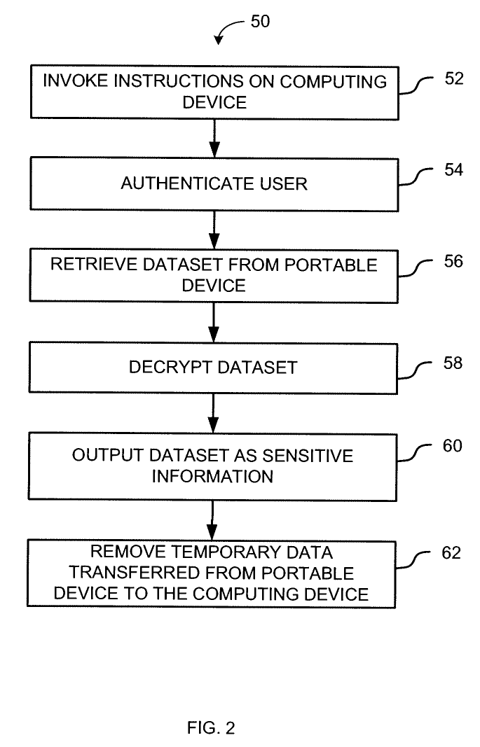

Referring now to FIG. 2, a flowchart is provided illustrating example operations 50 for retrieval of sensitive information in accordance with one embodiment of the invention. These retrieval operations 50 are reciprocal in nature to those of the storage operations 30 and, as such, the invocation process of operation 52 and the authentication process of operation 54 are is similar to those of operations 32 and 34 respectively, as described above with respect to FIG. 1.

Once a user is authenticated, the user may choose to retrieve sensitive information stored in the encrypted database. In order to do this, operation 56 retrieves a dataset from datastore on the portable device and then the dataset is decrypted at operation 58. As previously noted, in embodiments where the user credentials were utilized as a key in the encryption of the dataset, the user credentials are used as a key during the decryption process of operation 58. Additionally, like the encryption and storage processes of FIG. 1, the decryption process of operation 58 can also be concurrently performed with the retrieval process of operation 56.

Upon decryption of the dataset, the resulting sensitive information is outputted at operation 60. This output process may further comprise exporting the information to a file or an application that is currently running on the computing device. For example, in the case of login information, operation 60 can automatically output the username and password within the login information into the proper fields of a website currently displayed in a web browser application.

Subsequently, operation 62 (like operation 42 of FIG. 1) removes any temporary data that may have been transferred from the portable device to the computing device during the embodiment's performance (i.e., execution of instructions). As in operation 42, such temporary data may reside in the computing device in a variety of locations including a temporary memory space, RAM, or the hard disk drive. Accordingly, sensitive information that was retrieved, decrypted and outputted during operation of the embodiment cannot be obtained by other applications or processes running on the computing device.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

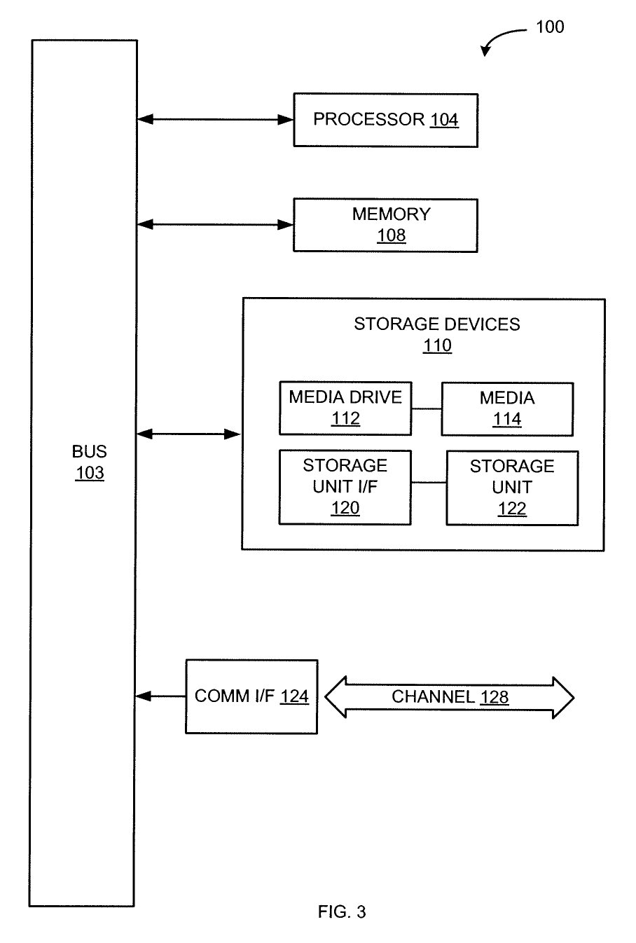

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example-computing module is shown in FIG. 3. Various embodiments are described in terms of this example-computing module 100. After reading this description, it will become apparent to a person skilled in the relevant art how to implement the invention using other computing modules or architectures.

Referring now to FIG. 3, computing module 100 may represent, for example, computing or processing capabilities found within computing devices such as desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 100 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 100 might include, for example, one or more processors, controllers, control modules, or other processing devices, such as a processor 104. Processor 104 might be implemented using a general-purpose or special-purpose processing engine such as, for example, a microprocessor, controller, or other control logic. In the example illustrated in FIG. 1, processor 104 is connected to a bus 103, although any communication medium can be used to facilitate interaction with other components of computing module 100 or to communicate externally.

Computing module 100 might also include one or more memory modules, simply referred to herein as main memory 108. For example, preferably random access memory (RAM) or other dynamic memory, might be used for storing information and instructions to be executed by processor 104. Main memory 108 might also be used for storing temporary variables or other intermediate information during execution of instructions to be executed by processor 104. Computing module 100 might likewise include a read only memory (“ROM”) or other static storage device coupled to bus 103 for storing static information and instructions for processor 104.

The computing module 100 might also include one or more various forms of information storage mechanism 110, which might include, for example, a media drive 112 and a storage unit interface 120. The media drive 112 might include a drive or other mechanism to support fixed or removable storage media 114. For example, a hard disk drive, a floppy disk drive, a magnetic tape drive, an optical disk drive, a CD or DVD drive (R or RW), or other removable or fixed media drive might be provided. Accordingly, storage media 114 might include, for example, a hard disk, a floppy disk, magnetic tape, cartridge, optical disk, a CD or DVD, or other fixed or removable medium that is read by, written to or accessed by media drive 112. As these examples illustrate, the storage media 114 can include a computer usable storage medium having stored therein computer software or data.

In alternative embodiments, information storage mechanism 110 might include other similar instrumentalities for allowing computer programs or other instructions or data to be loaded into computing module 100. Such instrumentalities might include, for example, a fixed or removable storage unit 122 and an interface 120. Examples of such storage units 122 and interfaces 120 can include a program cartridge and cartridge interface, a removable memory (for example, a flash memory or other removable memory module) and memory slot, a PCMCIA slot and card, and other fixed or removable storage units 122 and interfaces 120 that allow software and data to be transferred from the storage unit 122 to computing module 100.

Computing module 100 might also include a communications interface 124. Communications interface 124 might be used to allow software and data to be transferred between computing module 100 and external devices. Examples of communications interface 124 might include a modem or softmodem, a network interface (such as an Ethernet, network interface card, WiMedia, IEEE 802.XX or other interface), a communications port (such as for example, a USB port, IR port, RS232 port Bluetooth® interface, wireless USB, or other port), or other communications interface. Software and data transferred via communications interface 124 might typically be carried on signals, which can be electronic, electromagnetic (which includes optical) or other signals capable of being exchanged by a given communications interface 124. These signals might be provided to communications interface 124 via a channel 128. This channel 128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 108, storage unit 120, media 114, and signals on channel 128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 100 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer program product having instructions embedded in a computer useable medium, the instructions configured to cause a processor to perform the operations of:
authenticating a user by confirming one or more user credentials;
receiving sensitive information as a dataset;
encrypting the dataset using a cipher; and
storing the dataset on the portable device;
wherein the instructions are invoked when the portable device is attached to a computing device, the instructions reside on the portable device and remain on the portable device during execution of the instructions, and once terminated the instructions remove temporary data that was transferred from the portable device to the computing device during execution of the instructions.

2. The computer program product of claim 1, wherein the one or more user credentials include a username and password, a personal identification number, and biometric information.

3. The computer program product of claim 1, wherein one or more of the user credentials is used as a key for the cipher.

4. The computer program product of claim 1, wherein the sensitive information includes identification information, general security information, and system credentials.

5. The computer program product of claim 1, wherein the operations of encrypting and storing the dataset are performed concurrently.

6. The computer program product of claim 1, wherein the dataset is stored in one or more databases residing on the portable device.

7. The computer program product of claim 1, wherein the portable device is a portable storage device or a hand-held device, wherein the portable storage device includes a flash memory device, a secure digital memory card, a removable USB drive, an external hard disk device, and an external solid state hard disk device; and the hand-held device includes a personal digital assistant, a smartphone, or a portable media player.

8. The computer program product of claim 1, wherein the portable device attaches to the computing device through a physical interface or wireless interface, wherein the physical interface includes a serial port, a USB, a Firewire port, and an eSATA port; and the wireless interface includes a Bluetooth interface, a wireless USB, or a wireless LAN interface.

9. The computer program product of claim 1, wherein the computing device includes a personal computer, laptop, personal digital assistant, smartphone, or gaming console.

10. The computer program product of claim 1, further performing the operation of establishing an initial setup after the instructions are invoked.

11. The computer program product of claim 1, wherein the operation of authenticating the user involves authentication of one or more of the user credentials against a user list or a user group.

12. The computer program product of claim 1, wherein the processor resides in the portable device.

13. A computer program product having instructions embedded in a computer useable medium, the instructions configured to cause a processor to perform the operations of:
authenticating a user by confirming one or more user credentials;
retrieving a dataset from the portable device;
decrypting the dataset using the cipher; and
outputting the dataset as sensitive information;
wherein the instructions are invoked when the portable device is attached to a computing device, the instructions reside on the portable device and remain on the portable device during execution of the instructions, and once terminated the instructions remove temporary data that was transferred from the portable device to the computing device during execution of the instructions.

14. The computer program product of claim 13, wherein the one or more user credentials include a username and password, a personal identification number, and biometric information.

15. The computer program product of claim 13, wherein one or more of the user credentials is used as a key for the cipher.

16. The computer program product of claim 13, wherein the sensitive information includes identification information, general security information, and system credentials.

17. The computer program product of claim 13, wherein the operations of retrieving and decrypting the dataset are performed concurrently.

18. The computer program product of claim 13, wherein the dataset is retrieved from one or more databases residing on the portable device.

19. The computer program product of claim 13, wherein the portable device is a portable storage device or a hand-held device, wherein the portable storage device includes a flash memory device, a secure digital memory card, a removable USB drive, an external hard disk device, and an external solid state hard disk device; and the hand-held device includes a personal digital assistant, a smartphone, or a portable media player.

20. The computer program product of claim 13, wherein the portable device attaches to the computing device through a physical interface or wireless interface, wherein the physical interface includes a serial port, a USB, a Firewire port, and an eSATA port; and the wireless interface includes a Bluetooth interface, a wireless USB, or a wireless LAN interface.

21. The computer program product of claim 13, wherein the computing device includes a personal computer, laptop, personal digital assistant, smartphone, or gaming console.

22. The computer program product of claim 13, wherein the operation of authenticating the user involves authentication of one or more of the user credentials against a user list or a user group.

23. The computer program product of claim 13, wherein outputting the sensitive information involves exporting the sensitive information to an external file or to an application running on the computing device.

24. The computer program product of claim 13, wherein the processor resides in the portable device.

25. A portable device having instructions embedded in a computer readable medium, the instructions configured to cause a processor to perform the operations of:
authenticating a user by confirming one or more user credentials;
receiving sensitive information as a dataset;
encrypting the dataset using a cipher;
storing the dataset on the portable device;
retrieving the dataset from the portable device;
decrypting the dataset using the cipher; and
outputting the dataset as sensitive information;
wherein the instructions are invoked when the portable device is attached to a computing device, the instructions reside on the portable device and remain on the portable device during execution of the instructions, and once terminated the instructions remove temporary data that was transferred from the portable device to the computing device during execution of the instructions.

26. The portable device of claim 25, wherein the one or more user credentials include a username and password, a personal identification number, and biometric information.

27. The portable device of claim 25, wherein one or more of the user credentials is used as a key for the cipher.

28. The portable device of claim 25, wherein the sensitive information includes identification information, general security information, and system credentials.

29. The portable device of claim 25, wherein the operations of encrypting and storing the dataset are performed concurrently.

30. The portable device of claim 25, wherein the operations of retrieving and decrypting the dataset are performed concurrently.

31. The portable device of claim 25, wherein the dataset is stored in one or more databases residing on the portable device.

32. The portable device of claim 25, wherein the dataset is retrieved from one or more databases residing on the portable device.

33. The portable device of claim 25, wherein the portable device is a portable storage device or a hand-held device, wherein the portable storage device includes a flash memory device, a secure digital memory card, a removable USB drive, an external hard disk device, and an external solid state hard disk device; and the hand-held device includes a personal digital assistant, a smartphone, or a portable media player.

34. The portable device of claim 25, wherein the portable device attaches to the computing device through a physical interface or wireless interface, wherein the physical interface includes a serial port, a USB, a Firewire port, and an eSATA port; and the wireless interface includes a Bluetooth interface, a wireless USB, or a wireless LAN interface.

35. The portable device of claim 25, wherein the computing device includes a personal computer, laptop, personal digital assistant, smartphone, or gaming console.

36. The portable device of claim 25, further performing the operation of establishing an initial setup after the instructions are invoked.

37. The portable device of claim 25, wherein the operation of authenticating the user involves authentication of one or more of the user credentials against a user list or a user group.

38. The portable device of claim 25, wherein outputting the sensitive information involves exporting the sensitive information to an external file or to an application running on the computing device.

39. The portable device of claim 25, wherein the processor resides in the portable device.
